(19) United States
(12) Patent Application Publication
(10) Pub. No.: US 2005/0183508 A1
(43) Pub. Date: Aug. 25, 2005

(54) Pressure sensor for detecting pressure by using capacitance variation according to deflection of diaphragm

(75) Inventor: Hideaki Sato, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/059,161

(22) Filed: Feb. 15, 2005

(30) Foreign Application Priority Data
Feb. 23, 2004 (JP) 2004-045948

(51) Int. Cl. G01L 7/08

(52) U.S. Cl. 73/715

(57) ABSTRACT

A pressure sensor includes a base, a fixed electrode provided on the surface of the base, an insulating layer laminated on the fixed electrode to cover the fixed electrode, and a conductive diaphragm which is disposed to face the fixed electrode with a predetermined gap above the insulating layer. The pressure sensor detects a variation of a capacitance between the fixed electrode and the diaphragm by a deflection of the diaphragm when a pressure is applied to the diaphragm. A protrusion 3a protruding toward the diaphragm is formed on the insulating layer.

### BACKGROUND OF THE INVENTION

1. Field of the Invention

The present invention relates to a structure of a pressure sensor for detecting pressure using a capacitance variation according to the deflection of a diaphragm.

2. Description of the Related Art

A structure of a conventional pressure sensor is known. Such a pressure sensor generally includes a diaphragm having a conductive surface, an electrode formed of a metal film, and a base body provided with a dielectric film for covering an upper side thereof, in which the diaphragm and the electrode face each other and are bonded to each other with a gap between the diaphragm and the dielectric film (for example, see Japanese Unexamined Patent Application Publication No. 2002-195903).

Hereinafter, the structure of the conventional pressure sensor will be explained with reference to the drawings.

FIG. 9 shows the conventional pressure sensor, in which FIG. 9A is a plan view of the pressure sensor, FIG. 9B is a front cross-sectional view of the pressure sensor, and FIG. 9C is a bottom view showing an electrode of the pressure sensor.

In the drawings, a diaphragm 103 of a structure 101, for example, is formed so as to be hollow by etching a wafer made of single crystal silicon. A base body 102 may include a glass plate, a ceramic plate, or a rigid plastic plate, preferably, the glass plate, so long as it a stated electrically insulated from an electrode 104 can be secured. The electrode 104 is formed by depositing or plating a metallic material, such as gold or silver on the surface of the base body 102. A dielectric film 105 is made of an insulating material, such as glass or ceramic.

In addition, the electrode 104 has a shape in which its longitudinal dimension is gradually increased from a transverse center thereof toward a transverse end thereof, as shown in FIG. 9C.

The base body 102 comprises a terminal 107 which is connected to the electrode 104 and extends to a side edge of the base body 102, and a terminal 106 which is provided on the dielectric film 105 and electrically connected to the structure 101.

A gap 18 formed between the dielectric film 105 of the base body 102 and the diaphragm 103 is in a state of a vacuum so that the diaphragm 103 easily comes in contact with the dielectric film 105 by the pressure or has no temperature characteristic. The height of the gap 108 is properly selected.

In the pressure sensor 110, the diaphragm 103 is deflected toward the dielectric film 105 according to the variation of the outside pressure so that the diaphragm 103 comes in contact with the dielectric film 105. The capacitance between the diaphragm 103 and the electrode 104 is varied according to the contact area that the diaphragm 103 comes in contact with the dielectric film 105. The pressure applied to the diaphragm 103 is measured by detecting the variation of the capacitance between the terminal 106 connected to the structure 101 and the terminal 107 connected to the electrode 104.

This pressure sensor 110 keeps the increasing ratio of an increase in pressure to the contact area (the area that the diaphragm 103 comes in contact with the electrode 104) constant and improves the linear relationship between the increase in pressure and an increase in capacitance and by providing the electrode 104 having a shape in which its longitudinal dimension is gradually increased from the transverse center thereof to the transverse end thereof.

Recently, in order to increase the measurement accuracy of the pressure sensor, it is necessary to increase the variation amount in the measured range. However, in the conventional pressure sensor for measuring the pressure in a state in which the diaphragm is brought in contact with the dielectric film, there is a problem in that the capacitance to the initial measurement pressure cannot be lowered. Thus, it is difficult to increase the variation amount in the measured range. Therefore, a structure may be considered in which a portion of a fixed electrode corresponding to the portion of the diaphragm which comes in contact with the dielectric film is cut away to lower the capacitance to the initial measurement pressure. However, in this structure, there is a problem in that lowering of capacitance is limited.

### SUMMARY OF THE INVENTION

Accordingly, an object of the present invention is to solve the above-mentioned problems, and provide a pressure sensor capable of increasing the variation amount in the measured range by lowering the capacitance to the initial measurement pressure.

In order to solve the above-mentioned object, in a first aspect of the present invention, a pressure sensor comprises a base, a fixed electrode provided on a surface of the base, an insulating layer laminated on a fixed electrode to cover the fixed electrode, and a conductive diaphragm disposed to face the fixed electrode with a predetermined gap above the insulating layer, the pressure sensor detects a variation of a capacitance of the fixed electrode by a deflection of the diaphragm when a pressure is applied to the diaphragm, and a protrusion protruding toward the diaphragm is formed on the insulating layer.

Further, in a second aspect, the protrusion is disposed at a location which is almost at the center of the fixed electrode.

Further, in a third aspect, a cutout portion is formed at the center of the fixed electrode with respect to a portion with which the diaphragm comes in contact.

Further, in a fourth aspect, the fixed electrode has a disk shape, and the cutout portion has a star-shaped through-hole having a plurality of sharpened portions provided radially from the center of the disk to the periphery thereof.

Further, the fixed electrode has a disk shape and the cutout portion has a large hole formed at the center of the disk, and a plurality of small holes provided around the large hole.

As mentioned above, the pressure sensor of the present invention comprises a base, a fixed electrode provided on a surface of the base, an insulating layer laminated on a fixed electrode to cover the fixed electrode, and a conductive diaphragm disposed to face the fixed electrode with a predetermined gap above the insulating layer. The pressure sensor detects a variation of a capacitance of the fixed electrode by a deflection of the diaphragm when a pressure is applied to the diaphragm. A protrusion protruding toward the diaphragm is formed on the insulating layer. Thereby, the distance between the fixed electrode and the portion which the diaphragm comes in contact with the insulating layer can be increased. Thus, the capacitance to the initial measurement pressure when the pressure measurement is started in a state in which the diaphragm comes in contact with the insulating layer can be lowered.

Further, since the protrusion is disposed at a location which is almost at the center of the fixed electrode, the center of the diaphragm which is first deflected upon application of a pressure securely comes in contact with the protrusion provided at the center of the fixed electrode. Thus, the capacitance to the initial measurement pressure can be lowered.

In addition, since the cutout portion is formed at the center of the fixed electrode with respect to a portion with which the diaphragm comes in contact, the area of the fixed electrode facing the diaphragm is reduced, and thus the capacitance to the initial measurement pressure can be further lowered.

Moreover, since the fixed electrode has a disk shape, and the cutout portion has a star-shaped through-hole having a plurality of sharpened portions provided radially from the center of the fixed electrode to the periphery thereof, the area of the fixed electrode facing the diaphragm is gradually increased toward the outside, and thus the saturation in the high-pressure region of the outside can be lowered.

Further, since the fixed electrode has a disk shape, and the cutout portion has a large hole formed at the center of the fixed electrode and a plurality of small holes provided around the large hole, the area of the fixed electrode facing the diaphragm is gradually increased toward the outside, and thus the saturation in the high-pressure region of the outside can be lowered. Further, the sticking between the insulating layer and the base is enhanced by the virtue of the small holes, and thus the fixed electrode can be prevented from being stripped.

### BRIEF DESCRIPTION OF THE DRAWINGS

FIG. 1 is a cross-sectional view showing a pressure sensor according to a first embodiment of the present invention;

FIG. 2 is a plan view showing the fixed electrode of the pressure sensor to the first embodiment of the present invention;

FIG. 3 is a cross-sectional view showing a pressure sensor according to a second embodiment of the present invention;

FIG. 4 is a plan view showing a fixed electrode of the pressure sensor according to the second embodiment of the present invention;

FIG. 5 is a cross-sectional view showing a pressure sensor according to a third embodiment of the present invention;

FIG. 6 is a plan view showing a fixed electrode of the pressure sensor to the third embodiment of the present invention;

FIG. 7 is a plan view showing a fixed electrode of a pressure sensor according to a fourth embodiment of the present invention;

FIG. 8 is a graph showing the relationship between the pressure and the capacitance of the pressure sensor; and

FIG. 9 shows a conventional pressure sensor, in which FIG. 9A is a plan view of the pressure sensor, FIG. 9B is a front cross-sectional view of the pressure sensor, and FIG. 9C is a bottom view showing an electrode of the pressure sensor.

### DESCRIPTION OF THE PREFERRED EMBODIMENT

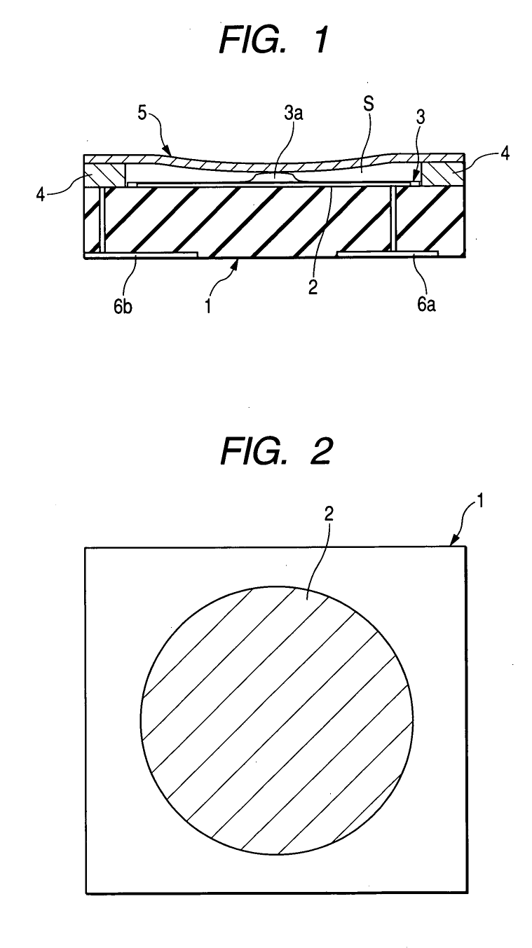

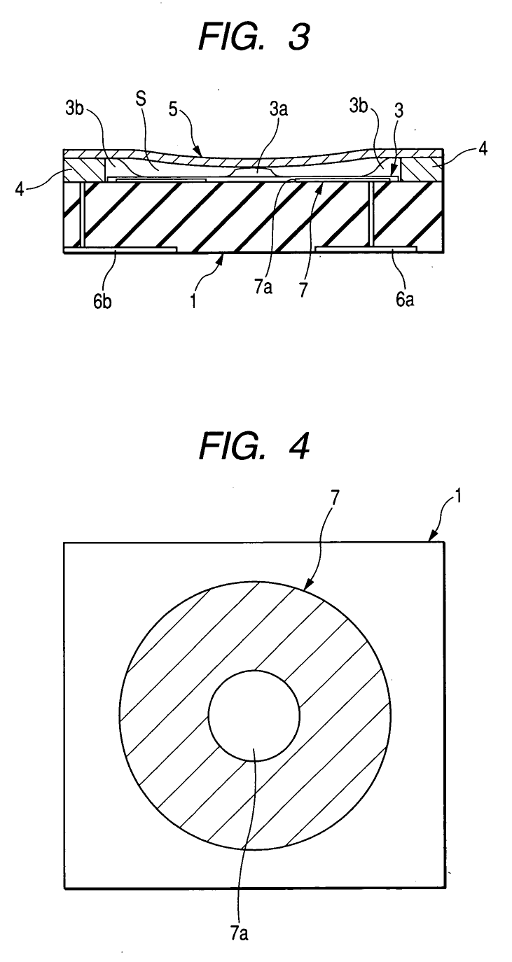

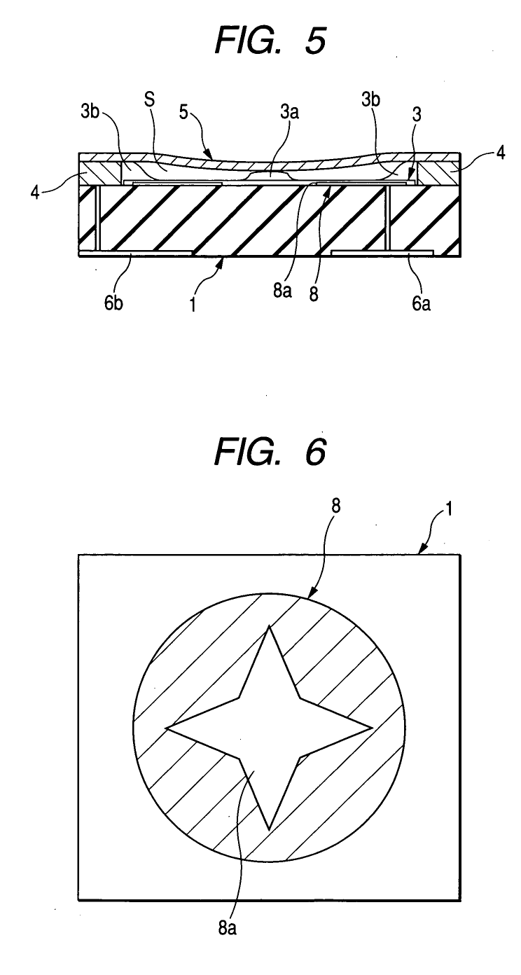

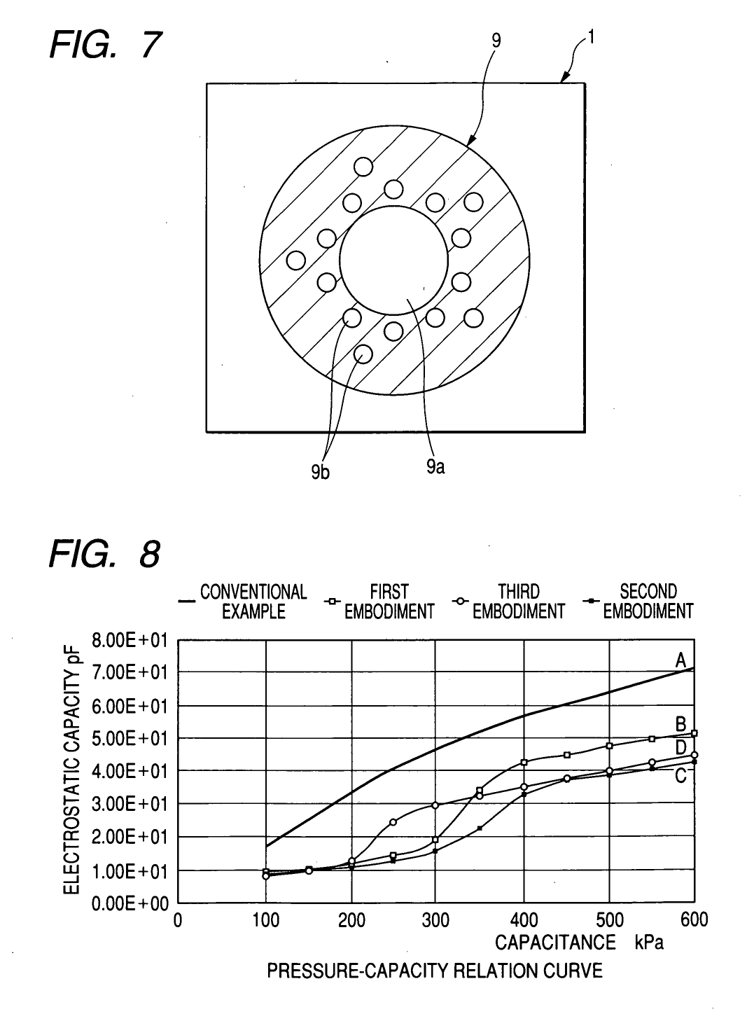

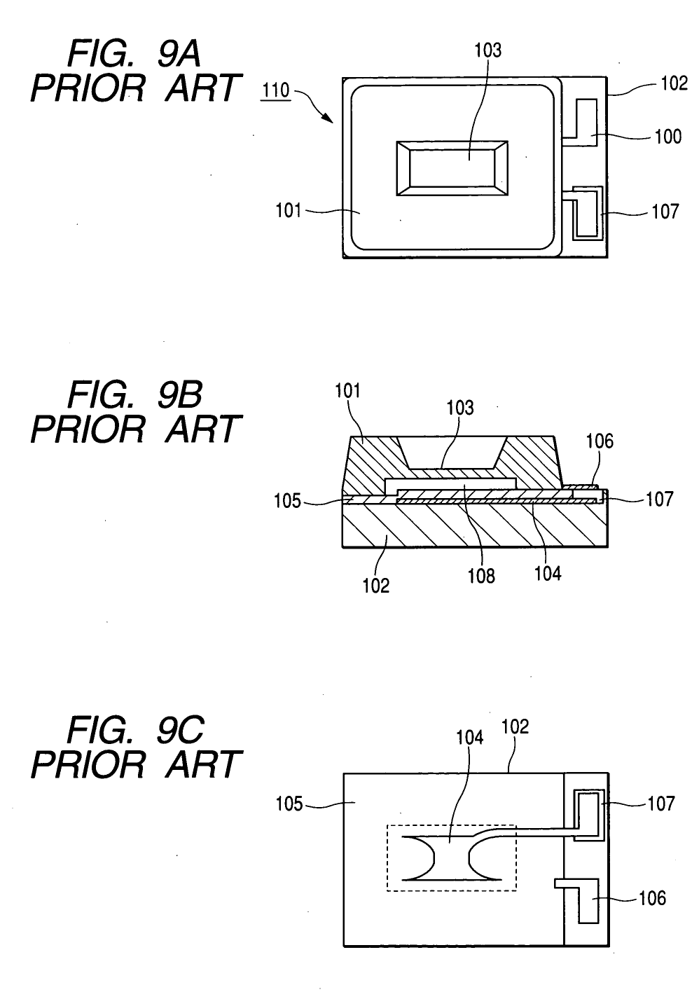

Hereinafter, embodiments of a pressure sensor of the present invention will be described with reference to FIGS. 1 to 8. FIG. 1 is a cross-sectional view of a pressure sensor according to a first embodiment of the present invention, FIG. 2 is a plan view of the fixed electrode of the pressure sensor, FIG. 3 is a cross-sectional view showing a pressure sensor according to a second embodiment of the present invention, FIG. 4 is a plan view of the fixed electrode of the pressure sensor according to the second embodiment of the present invention, FIG. 5 is a cross-sectional view showing a pressure sensor according to a third embodiment of the present invention, FIG. 6 is a plan view of the fixed electrode of the pressure sensor according to the third embodiment of the present invention, FIG. 7 is a plan view of the fixed electrode of the pressure sensor according to a fourth embodiment of the present invention, and FIG. 8 is a graph showing the relationship between the pressure and the capacitance of the pressure sensor.

The pressure sensor related to the present invention measures the pressure by detecting the variation of the contact area which a diaphragm comes in contact with an insulating layer (dielectric layer) by the pressure and by measuring the capacitance between an electrode and the diaphragm, and comprises a base 1, a fixed electrode provided on a surface of the base 1, an insulating layer laminated on the fixed electrode to cover the fixed electrode, and a diaphragm which is provided to face the fixed electrode with a predetermined gap above the insulating layer.

In FIGS. 1 and 2, the base 1 is formed of a thick insulating material, such as ceramic, and has a rectangular shape. The surface (upper surface) of the base 1 is provided with a circular fixed electrode 2 made of a conductive plate-shaped metallic material. In this case, as the metallic material, various kinds of metal (for example, Al, Cr, Cu, Ti, etc.) are generally used.

In addition, on the fixed electrode 2, an insulating layer 3 is laminated so as to cover the fixed electrode 2. The insulating layer 3 is made of an insulating material such as glass, ceramic, polyimide, or silicon, and constitutes a dielectric layer. Further, the insulating layer 3 is formed with an upwardly protruding protrusion 3a, at a position which is almost at the center of the fixed electrode 2. In this case, the insulating layer 3 is made of silicon nitride, and the protrusion 3a is laminated on the insulating layer 3 by a method such as sputtering.

Moreover, an annular conductive member 4 is stuck on the upper surface of a peripheral portion of the base 1 on which the fixed electrode 2 is formed. A plate-shaped diaphragm 5 is mounted on the upper surface of the conductive member 4. The diaphragm 5 is made of a conductive thin metal plate having elasticity or a sheet-like rubber material. In the case of using the rubber as the diaphragm, a conductive material, such as carbon, is covered on the surface thereof. Also, the conductive member 4 and the diaphragm 5 may be integrally formed with each other.

Furthermore, when the diaphragm 5 is mounted on the conductive member 4, the diaphragm 5 is disposed to face the fixed electrode 2 with a predetermined gap S above the insulating layer 3 which is laminated to cover the fixed electrode 2. Since the protrusion 3a is provided at the center of the fixed electrode 2, the gap S from the diaphragm 5 is larger than that of the case that there is no protrusion 3a.

In addition, the gap S formed between the diaphragm 5 and the insulating layer 3 laminated to cover the fixed electrode 2 is in state of vacuum such that the diaphragm 5 easily comes in contact with the insulating layer 3 by the pressure and does not have a temperature characteristic. The height of the gap S, that is, the dimension between the insulating layer 3 and the diaphragm 5 is properly selected in accordance with the dimension (size or thickness) of the diaphragm 5.

In this pressure sensor, the diaphragm 5 is deflected toward the insulating layer 3 according to the variation of outside pressure such that the diaphragm 5 comes in contact with the insulating layer 3. Further, since the capacitance between the diaphragm 5 and the electrode 2 is varied in accordance with the contact area which the diaphragm 5 comes in contact with the insulating layer 3, the pressure applied to the diaphragm 5 is measured by detecting the variation of the capacitance. In this case, the fixed electrode 2 and the diaphragm 5 are connected with connecting leads 6a and 6b, respectively, and the variation of the capacitance is detected via the connecting leads 6a and 6b.

Further, since the diaphragm 5 comes in contact with the insulating layer 3 having high dielectric constant while being deflected by applying the pressure, the variation of the capacitance to the deflection can be further increased.

Next, the operation of the pressure sensor having the above-mentioned structure will be explained.

FIG. 1 shows a case that the pressure applied to the diaphragm 5 is relatively small, that is, the case of initial measurement pressure. In this case, only the center of the diaphragm 5 comes in contact with the protrusion 3a of the facing insulating layer 3, and the remaining peripheral portion thereof faces the insulating layer 3 with a constant gap S. In this state, since the gap S between the diaphragm 5 and the fixed electrode 2 exists, the capacitance has a relatively small value.

In the present embodiment, by providing the protrusion 3a on the insulating layer 3, the distance between the fixed electrode 2 and the portion of the diaphragm 5 which contacts the insulating layer 3 can be increased. Accordingly, the capacitance to the initial measurement pressure can be lowered when the pressure measurement is started in state in which the diaphragm 5 comes in contact with the insulating layer 3.

In addition, since the protrusion 3a is disposed almost at the center of the fixed electrode 2, the center of the diaphragm 5 which is first deflected upon application of a pressure securely comes in contact with the protrusion 3a provided at the center of the fixed electrode 2. Thus, the capacitance to the initial measurement pressure can be lowered.

From this state, when larger pressure is applied to the diaphragm 5, the entire peripheral portion of the diaphragm 5 in addition to the center thereof comes in contact with the facing insulating layer 3, and thus the gap S substantially disappears. In this state, since there is little gap S between the diaphragm 5 and the fixed electrode 2, the capacitance has a large value.

In this case, since the diaphragm 5 is formed so that the shape of the interior thereof corresponding to the gap S is circular, it can be smoothly deflected, and thus the operation can be stable. Also, since there is no corner portion, the damage can be prevented from being caused.

FIGS. 3 and 4 show a second embodiment of the present invention.

In the present embodiment, the structure of the fixed electrode is partially different from that of the first embodiment. The same components as those of the first embodiment are denoted by the same reference numerals, and the detailed description thereof will be omitted.

In other words, the structure of the present embodiment is the same as that of the first embodiment in that the upwardly protruding protrusion 3a is formed at a position which is almost at the center of the fixed electrode. However, the fixed electrode 7 of the present embodiment is formed at the center thereof with a cutout portion 7a with respect to a portion with which the diaphragm comes in contact, as shown in FIG. 4. Further, the insulating layer 3 is also formed within the cutout portion 7a, and the protrusion 3a is formed above the cutout portion 7a.

As described above, in the present embodiment, since the cutout portion 7a is formed at the center of the fixed electrode 7 with respect to a portion with which the diaphragm 5 comes in contact, the area of the fixed electrode 7 facing the diaphragm 5 is reduced, and thus the capacitance to the initial measurement pressure can be further lowered.

Further, in the present embodiment, an annular bulging portion 3b bulged upwardly from an outer peripheral edge of the insulating layer 3 is formed under the peripheral edge of the circular interior of the diaphragm 5 corresponding to the gap S. By forming the bulging portion 3b, the bulging portion 3b is disposed in a state in which it is close to or abuts on the diaphragm 5 disposed to face the fixed electrode 7 even when large pressure is applied to the diaphragm 5. Thus, when the diaphragm 5 is deflected, the stress of the peripheral edge of the interior thereof where a stress is apt to be concentrated is reduced, and thus the damage or destruction of the diaphragm 5 can be prevented from being caused.

FIGS. 5 and 6 show a third embodiment of the present invention.

In the present embodiment, the structure of the cutout portion formed at the fixed electrode is partially different from that of the second embodiment. The same components as those of the first and second embodiments are denoted by the same reference numerals, and the detailed description thereof is omitted.

In other words, the structure of the present embodiment is the same as those of the first and second embodiments in that the upwardly protruding protrusion 3a is formed at a position which is almost at the center of the fixed electrode. However, the fixed electrode 8 of the present embodiment is formed at the center thereof with a cutout portion 8a having a star-shaped through-hole having a plurality of sharpened portions provided radially from the center toward the periphery, with respect to a portion with which the diaphragm 5 comes in contact, as shown in FIG. 6. Further, the insulating layer 3 is formed within the cutout portion 8a, and the protrusion 3a is formed above the cutout portion 8a.

As described above, in the present embodiment, since the cutout portion 8a having the star-shaped through-hole having a plurality of the sharpened portions provided radially from the center toward the periphery is formed at the center of the fixed electrode 8, with respect to a portion with which the diaphragm 5 comes in contact, the capacitance to the initial measurement pressure can be lowered, and the area of the fixed electrode 8 facing the diaphragm 5 is gradually increased toward the outside thereof. Thus, the saturation in the high-pressure region of the outside can be lowered.

Further, in the present embodiment, an annular bulging portion 3b bulged upwardly from the outer peripheral edge of the insulating layer 3 is formed under the peripheral edge of the circular interior of the diaphragm 5 corresponding to the gap S of the diaphragm 5. Thus, the bulging portion 3b is disposed in a state in which it is close to or abuts on the diaphragm 5 disposed to face the fixed electrode 8 even when large pressure is applied to the diaphragm 5. Accordingly, when the diaphragm 5 is deflected, the stress of the peripheral edge of the interior thereof where a stress is apt to be concentrated is reduced, and thus the damage or destruction of the diaphragm 5 can be prevented from being caused.

FIG. 7 shows a fourth embodiment of the present invention. In the present embodiment, the structure of the cutout portion formed at the fixed electrode is partially different from those of the first, second and third embodiments.

In other words, the fixed electrode 9 is formed with a cutout portion having a large hole 9a provided at the center with respect to a portion with which the diaphragm 5 comes in contact, and a plurality of small holes 9b provided around the large hole 9a, as shown in FIG. 7. Further, the insulating layer 3 is also formed within the hole 9a or 9b, and the protrusion 3a is formed above the hole 9a.

As described above, in the present embodiment, since the cutout portion having the large hole 9a provided at the center with respect to a portion with which the diaphragm 5 comes in contact, and the plurality of the small holes 9b provided around the large hole 9a are formed, the capacitance to the initial measurement pressure can be lowered, and the area of the fixed electrode 9 facing the diaphragm 5 is gradually increased toward the outside, the saturation in the high-pressure region of the outside can be lowered. In addition, the sticking between the insulating layer 3 and the base 1 is enhanced by virtue of the plurality of small holes 9b, and thus the fixed electrode 9 can be prevented from being stripped.

FIG. 8 is a graph showing the relationship between the capacitance and the pressure of the pressure sensor. Here, the axis of abscissa shows the pressure applied to the diaphragm 5, and the axis of ordinate shows the variation of the capacitance between the diaphragm 5 and each of the fixed electrodes 2, 7 and 8 with respect to the pressure.

In FIG. 8, the curve A shows the case that the dielectric layer 105 covering the electrode 104 is flat, that is, the protrusion protruding toward the diaphragm 103 is not formed on the dielectric layer 105. In this case, the capacitance between the diaphragm 103 and the electrode 104 is increased in accordance with the pressure applied to the diaphragm 103, but the capacitance to the initial measurement pressure (about 100 kPa) is about 18 pF when the pressure measurement is started in a state in which the diaphragm 103 is brought in contact with the dielectric layer 105.

On the contrary, the curve B shows the case that the protrusion 3a protruding toward the diaphragm 5 is formed on the insulating layer 3 covering the fixed electrode 2, as shown in FIGS. 1 and 2. In this case, the curve has a parabolic shape, but, when the pressure measurement is started in a state in which the diaphragm 5 is brought in contact with the insulating layer 3, the capacitance to the initial measurement pressure (about 100 kPa) is about 9 pF and is lower than that of the conventional example.

As described above, in the present embodiment, since the distance between the fixed electrode 2 and the portion of the diaphragm 5 which comes in contact with the insulating layer 3 can be increased by providing the protrusion 3a on the insulating layer 3, the capacitance to the initial measurement pressure can be lowered when the pressure measurement is started in a state the diaphragm 5 is brought in contact with the insulating layer 3.

In FIG. 8, the curve C shows the case that the circular cutout portion 7a is formed at the center of the fixed electrode 7, with respect to a portion with which the diaphragm 5 comes in contact, as shown in FIGS. 3 and 4, and the curve D shows the case that the star-shaped cutout portion 8a is formed at the center of the fixed electrode 8 with respect to a portion with which the diaphragm 5 comes in contact. In theses cases, when the pressure measurement is started in a state in which the diaphragm 5 comes in contact with the insulating layer 3, the capacitance to the initial measurement pressure (about 100 kPa) is about 8 pF and is much lower than that of the conventional example.

By forming the cutout portion 7a or 8a at the center of the fixed electrode 7 or 8 with respect to a portion with which the diaphragm 5 comes in contact, the area of the fixed electrode 7 or 8 facing the diaphragm 5 can be reduced, and thus the capacitance to the initial measurement pressure can be further lowered. By lowering the capacitance to the initial measurement pressure, the pressure sensor which can increase the variation amount in the measured range can be provided.

According to the embodiment of the present invention, the pressure sensor comprises the base 1, the fixed electrode 2, 7, 8 or 9 provided on the surface of the base 1, the insulating layer 3 laminated to cover the fixed electrode 2, 7, 8 or 9, the conductive diaphragm 5 disposed to face the fixed electrode 2, 7, 8 or 9 with the predetermined gap S above the insulating layer 3, and detects the variation of the capacitance between the fixed electrodes 2, 7, 8 or 9 and the diaphragm by the deflection of the diaphragm 5 when a pressure is applied to the diaphragm 5. The protrusion 3a protruding toward the diaphragm 5 is formed on the insulating layer 3. By providing the protrusion 3a on the insulating layer 3, the distance between the fixed electrodes 2, 7, 8 or 9 and the portion of the diaphragm 5 which comes in contact with the insulating layer 3 can be increased, and thus, when the pressure measurement is started in the state in which the diaphragm 5 comes in contact with the insulating layer 3, the capacitance for the initial measurement pressure can be lowered.

In addition, although various shapes of cutout portion 7a, 8a, 9a or 9b are formed in the fixed electrodes 7, 8 or 9 in the above-mentioned embodiments, the cutout portion is not necessarily needed in the fixed electrode. The upwardly protruding protrusion 3a may be formed on the insulating layer 3 at a position which is almost at the center of the fixed electrode 2, without forming the cutout portion as the fixed electrode 2. Thereby, by the simple structure, the capacitance to the initial measurement pressure can be securely lowered when the pressure measurement is started in a state in which the diaphragm 5 is brought in contact with the insulating layer 3.

1. A pressure sensor comprising:
a base,
a fixed electrode provided on a surface of the base,
an insulating layer laminated on a fixed electrode to cover the fixed electrode, and
a conductive diaphragm disposed to face the fixed electrode with a predetermined gap above the insulating layer, the pressure sensor detecting a variation of a capacitance of the fixed electrode by a deflection of the diaphragm when a pressure is applied to the diaphragm,
wherein a protrusion protruding toward the diaphragm is formed on the insulating layer.

2. The pressure sensor according to claim 1, wherein the protrusion is disposed at a location which is almost at the center of the fixed electrode.

3. The pressure sensor according to claim 2, wherein a cutout portion is formed at the center of the fixed electrode with respect to a portion with which the diaphragm comes in contact.

4. The pressure sensor according to claim 3, wherein the fixed electrode has a disk shape, and the cutout portion has a star-shaped through-hole having a plurality of sharpened portions provided radially from the center of the disk to the periphery thereof.

5. The pressure sensor according to claim 3, wherein the fixed electrode has a disk shape, and the cutout portion has a large hole formed at the center of the disk and a plurality of small holes provided around the large hole.
